(19) United States
(12) Patent Application Publication
(10) Pub. No.: US 2002/0042831 A1
(43) Pub. Date: Apr. 11, 2002

(54) System and method for building applications that adapt for multiple device and protocol standards

(76) Inventors: Jeffrey Capone, Scottsdale, AZ (US); Steven Hoffman, Fountain Hills, AZ (US); Pramod Immaneni, Tempe, AZ (US); Sudhakiran Mudiam, Tempe, AZ (US); Alpur Turgut, San Francisco, CA (US)

Correspondence Address: Ted Rittmaster, Foley & Lardner, 2029 Century Park East - Suite 3500, Los Angeles, CA, 90067-3021, US

(21) Appl. No.: 09/834,423

(22) Filed: Apr. 13, 2001

Related U.S. Application Data
(60) Provisional application No. 60/225,718, filed on Aug. 16, 2000.

(51) Int. Cl. G06F 15/16

(52) U.S. Cl. 709/230; 709/203

(57) ABSTRACT

A process and system for adapting an application created without regard to protocol or device to a particular protocol and device. An application developer may create content in an object oriented fashion using application programming interfaces (APIs) provided by the system. The resultant content may be protocol independent and device independent. When processed by the system, the system may first take the protocol independent and device independent content and render it to become protocol dependent and device independent using engines provided by the system. The system may then take the protocol dependent and device independent content and adapt it based on a resource descriptive framework (RDF) for a device to become protocol dependent and device dependent.

### BACKGROUND

1. Field of the Invention

The present invention relates to the field of information technology. Particular embodiments of the invention relate to systems and methods for developing content and applications for multiple device and protocol standards without regard to any particular device or protocol.

2. Related Art

The protocols and standards currently used by devices to transfer and communicate information are varied. Set-top boxes, cellular telephones, desktop PCs, personal digital assistants, smart phones, pagers, e-books, laptop PCs and other devices each have different capabilities and utilize different methods by which information is sent, received, displayed and interpreted. Further, markup languages used for presentation on these devices are also varied, some even being proprietary. These variances result in a lack of portability and an inability for content created for one device or protocol to be used by another.

Various attempts have been made to introduce consistency between devices and protocols. In some cases, these attempts have been effected by means of initiatives to adopt industry-wide standards. For example, in the wireless markets, there currently exists the Wireless Application Protocol (WAP), a set of specifications for developing applications that run on wireless devices. WAP is based on various Internet standards, such as the extensible markup language (XML) and the Internet protocol (IP). WAP, however, is optimized for narrow bandwidth networks and devices with limited display capabilities. Information transmitted via WAP is typically truncated for ease of transmission over mobile links and for viewing on small screens. It has been designed primarily by members of the cellular telephone and wireless communications industries and, consequently, it is primarily these industries that use WAP. It is a de facto standard, not a mandatory one, and so protocols other than WAP are also used within the cellular telephone industry. Thus, the cellular telephone industry, not to mention the entire wireless industry, has no standard protocol for the transfer and communication of information between servers and devices or between multiple devices.

Not surprisingly, the Internet industry is also replete with multiple protocols and standards. For example, millions of pages filled with text and graphic images are viewed daily on the world wide web, the graphical portion of the Internet, by Internet users all over the world. However, there currently exists no single standard for the creation of these documents. The most popular method for creating web pages is to use the ubiquitous HTML, or hypertext markup language. HTML is a set of codes (called “tags”) that allows ordinary text to be turned into instructions that generate web pages. It is relatively simple to use and has provided the means by which many people have created their own web pages. HTML, however, is not without its shortcomings. Its simplicity is also one of its limitations. Some types of characters simply cannot be printed using HTML. Also, because the number of HTML codes are limited, there is no way to guarantee that a web page designed using HTML will consistently be displayed exactly the same way on every computer or using every web browser. This is obviously troublesome for web page designers. In an attempt to alleviate this problem, newer versions of HTML are continuously being developed with enhanced code features. However, this has resulted in a multiplicity of HTML versions and has rendered the older versions of HTML obsolete. Consequently, the lack of consistency in web pages perpetuates.

In a further effort to address web page consistency issues and other problems associated with HTML, document formats such as the Portable Document Format (PDF) have been created. A web page designed using PDF contains every piece of information needed to display that page, including, without limitation, font type, layout, graphics spacing and colors. Thus, a web page created using PDF will be visually identical, or at least extremely similar, to all viewers regardless of the system used for viewing. PDF, however, is not a complete solution for viewing web pages. A PDF file cannot ascertain anything about the structure of the data it is presenting. As a result, HTML, which does have the capability to ascertain data structure, is frequently used to manage the delivery of PDF pages. Further, although PDF has become a de facto standard, it is proprietary, being owned by ADOBE SYSTEMS, INC., and, in order to view a PDF page, a user must have ADOBE® ACROBAT® software.

In addition to HTML and PDF, many other protocols exist for displaying content on the Internet. As is the case with wireless devices, and like PDF, many formats are proprietary. Compounding the problem, new devices that connect directly to the Internet, called Internet “appliances,” are constantly being developed and marketed, either using one of the varieties of protocols that currently exist for the Internet or relying on a proprietary system to transfer and display content. In either case, the Internet appliance developer is forced to make uneasy decisions regarding the selection of protocol, hoping that the protocol selected or developed for the new device will remain viable and acceptable to a wide market. This is not always the case, and the history of the Internet is laden with products that ultimately failed in the marketplace simply because of a poor choice in the selection of the method of transferring and displaying information.

The tremendous variety of protocols and devices currently in use presents significant challenges for those creating content and applications to be supported by the multitude of heterogeneous devices. The existence of a multitude of devices and protocols has forced application and content designers to design for a specific device or protocol. Rather than focusing exclusively on content or an application, content and application designers must devote valuable time and expense to modifying content or an application for each particular device that might be utilized for the application or to display the content and for the particular protocol of that device. For example, there currently exist systems that will determine which type of web browser exists on a user's device. If a NETSCAPE browser exists on the user's device, a pre-defined NETSCAPE web page is sent to the user with content designed specifically for the NETSCAPE environment. However, should a different web browser exist on the user's device, for example, a MICROSOFT web browser, a pre-defined MICROSOFT web page is sent to the user's device with content designed specifically for the MICROSOFT environment. Obviously, because much of the content originally created on one environment is fundamentally incompatible with another, the time and cost associated with this approach may be tremendous. Although the protocol and/or device might try to adapt to the demands of a particular application and try to display and communicate content as it was originally intended, most results are inadequate for their intended purposes.

Thus, what is needed is a system for creating applications and content that are independent of protocol and device, but that allows such content to be available and adapt to any protocol or any device.

### SUMMARY

The present invention is directed to a method and system that addresses the above-mentioned industry needs.

A method for creating protocol dependent and device dependent applications from protocol independent and device independent applications according to an embodiment of the present invention comprises receiving protocol independent and device independent content object; rendering the protocol independent and device independent content to protocol dependent and device independent content; and rendering the protocol dependent and device independent content to protocol dependent and device dependent content based on a resource descriptive framework (RDF) for the device.

In yet another embodiment, the step of rendering the protocol independent and device independent content to protocol dependent and device independent content may further comprise mapping the protocol independent and device independent content to a container storing protocol. The step of rendering the protocol dependent and device independent content to protocol dependent and device dependent content may further comprise registering the protocol dependent and device independent content with a handler storing device capabilities or an RDF.

In yet another embodiment, a method for creating protocol dependent and device dependent content from protocol independent and device independent content may further comprise providing actions to a content developer and may further comprise providing API's to a content developer for extending actions. The method may further comprise receiving an extended action from a content developer.

In yet another embodiment, the step of rendering the protocol independent and device independent content to protocol dependent and device independent content may further comprise instantiating a device object that consists of handlers (objects), one for each feature of the device, that controls the application for the device based on the RDF for that device.

In yet another embodiment, a system for creating protocol dependent and device dependent content from protocol independent and device independent content comprises class files; application programming interfaces for creating a protocol independent and device independent content object utilizing the class files; an engine for adapting the protocol independent and device independent content object into a protocol dependent and device independent content object based on the RDF for the device; and an engine for adapting the protocol dependent and device independent content object into a protocol dependent and device dependent content object.

In yet another embodiment, the protocol independent and device independent content object may be mapped into a container and the protocol dependent and device independent content may be registered with a handler that is instantiated based on the information contained in the RDF. The protocol independent and device independent content object may be created using object oriented programming and the protocol independent and device independent content object extends a first action. Further, the engine may instantiate a device object.

In yet another embodiment, a method for creating protocol dependent and device dependent content from protocol independent and device independent content comprises creating a protocol independent and device independent content object; rendering the protocol independent and device independent content to protocol dependent and device independent content; and rendering the protocol dependent and device independent content to protocol dependent and device dependent content. Further, creating protocol independent and device independent content may comprise using object oriented programming.

In yet another embodiment, the step of creating protocol independent and device independent content further comprises using application programming interfaces. The step of using application programming interfaces further comprises extending an action.

In yet another embodiment, a method for building an application once that may be used on multiple devices running multiple protocols according to an embodiment of the present invention comprises creating protocol independent and device independent content; adapting the application to multiple protocols; and adapting the application to multiple devices. Further, the step of adapting the application to multiple protocols may further comprise selecting one of the multiple protocols and rendering the application to the selected protocol. Further, the step of adapting the application to multiple devices may comprise selecting one of the multiple devices and adapting the application to the selected device.

In yet another embodiment, a method for building an application once that may be used on multiple devices running multiple protocols according to an embodiment of the present invention comprises creating protocol independent and device independent content; rendering content to multiple devices; and rendering the content to multiple protocols.

In yet another embodiment, a system for creating protocol dependent and device dependent content from protocol independent and device independent content according to an embodiment of the present invention comprises means for creating protocol independent and device independent content object; means for rendering the protocol independent and device independent content to protocol dependent and device independent content; and means for rendering the protocol dependent and device independent content to protocol dependent and device dependent content. Further, the means for creating protocol independent and device independent content may comprise means for using object oriented programming. Further, the means for creating protocol independent and device independent content further may comprise means for using application programming interfaces. Further, the means for using application programming interfaces further comprises means for extending an action.

### BRIEF DESCRIPTION OF THE DRAWINGS

These and other features, aspects, and advantages of the present invention will become better understood when viewed in light of the accompanying drawings where:

FIG. 1A is a block diagram of a networking environment in which an embodiment of the present invention may be used.

FIG. 1B is a flow diagram of a method for rendering protocol independent and device independent content into protocol dependent and device dependent content according to an embodiment of the present invention.

FIG. 2A is a generalized system according to an embodiment of the present invention on which software for rendering protocol independent and device independent content into protocol dependent and device dependent content may reside.

FIG. 2B is a block diagram of details of a servlet according to an embodiment of the present invention.

FIG. 3 is a flow diagram of a method for creating a content object according to an embodiment of the present invention.

FIG. 4 is an object diagram showing a content object according to an embodiment of the present invention.

FIG. 5 is a flow diagram of a method for rendering a protocol independent and device independent content into protocol dependent and device dependent content according to an embodiment of the present invention.

FIG. 6 is a flow diagram of a method for rendering a protocol independent and device independent content object into protocol dependent and device independent content according to an embodiment of the present invention.

FIG. 7 is an object diagram of a container for mapping device protocol to a content object according to an embodiment of the present invention.

FIG. 8 is an object representation of a content object registering with a handler according to an embodiment of the present invention.

FIG. 9 is a flow diagram of a method for registering a content object with a handler according to an embodiment of the present invention.

FIG. 10 is an object representation of a request for rendering content for a particular device according to an embodiment of the present invention.

FIG. 11 is an object representation of a method for rendering a protocol dependent and device dependent content into protocol dependent and device independent content according to an embodiment of the present invention.

### DETAILED DESCRIPTION

Implementation of embodiments of the present invention may be based conceptually on object oriented programming. Thus, a limited discussion of object oriented programming fundamentals is appropriate.

Traditional programming techniques typically follow some type of structured programming method. The use of structured programming methods typically results in programs with a hierarchy of program modules, each module having only one entry point and only one exit point, and in which control may be passed downward through the structure of the program without unconditional branches to higher levels of the structure. Most programs using structured programming methods rely on three basic control structures: 1) sequence, a control structure wherein program instructions are executed linearly, or one after another; 2) selection, a control structure whereby an instruction path is chosen based on a conditional test; and 3) iteration, a control structure whereby instructions are repeated. Also, in a structured programming environment, data structures and programming functions are separated.

Structured programming methods, however, while contributing to the design of programs that flow logically and are easy to read, generally do not facilitate the design of large software systems and complex data structures. Large software systems using structured programming methods can quickly become unwieldy and cumbersome. As programs and systems have become larger and data structures more complex, techniques such as object oriented programming have been developed so that larger software systems may be treated as “components.” Also, object oriented programming closely models the real world, as in the real world everything is an object.

Object oriented programming may be distinguished from structured programming and other programming techniques by the use of “objects.” An object can be thought of as a “black box,” the contents of which may be unknown (and need not be known) to the user of the object, and which contains both code (i.e., computer instructions) and data (i.e., information on which the computer instructions operate and perform). As an individual entity, an object is autonomous and performs a specific task. A user of an object needs to know only the specific task performed by the object and how to communicate with the object.

Communication with objects is effected via “messages.” An object that is sent a message is called the receiver of the message. The entity sending the message is called the sender of the message. A sender is generally not specifically concerned with the method used by the receiver in order to comply with the request contained in the message, but only that the receiver does comply with the request contained in the message.

Because access to an object is limited to communication via messages, most information relating to an object, including, but not limited to, details regarding how the function of the object is implemented and what data is needed by the object, is essentially hidden. This is generally not a problem since the internal operations of an object are typically not important to the user. Users of the object need only know what the object does and how to communicate with the object. The internal implementation and operation of the object can change as long as the interface to the user remains the same. The concept of keeping the information relating to an object hidden is sometimes referred to as “encapsulation.” In other words, objects are encapsulated.

An object is defined by its “class.” A class determines everything about an object. A class may be likened to a blueprint that defines an object. An object is an individual instance of a class. Thus, to instantiate a class is to create an object, and there may be multiple objects, or multiple instances of a class, all part of one class and having those properties defined by the class. For example, there may exist a class called “Dog.” From the class “Dog,” individual instances, or objects, of the class may be created, such as “beagle,” “poodle,” and “dalmation.” Thus, the Dog class defines everything necessary to understand what it means to be a Dog object, including, but not limited to, defining messages that a Dog object understands, which, in this case, might be, for example, “stay,” “sit,” and “come.”

A “base element” is a super class from which all classes may extend. Thus, to extend a base element or a super class means to add to the functionality of the base element or super class.

In the event a computer programmer or software engineer wants to define a class similar to a class already in existence, using object oriented programming techniques there is no need to redefine an entire new class. Rather, all that is necessary is to form a subclass of the existing class. The new subclass may inherit all the properties and characteristics of the existing class. This property is known as inheritance. Inheritance allows a class to assume the properties and characteristics of any other class to which it is related. Thus, a new class may be defined without having to rewrite source code, i.e., the program instructions. This may result in a tremendous savings in time for computer programmers and software engineers and is typically beneficial in large software systems and complex data structures. Generally, an existing class from which a new class is formed is called a “parent” class. A new class formed from a parent class is called a “child” class. Thus, in the context of object oriented programming class identification, a “parent” may have “children.”

A “resource” may be the specific data or content that is requested. For example, video, audio, text, a program, a file, an HTML page and a WML page may all be resources. A “document” is a collection of resources.

A “handler” is an object that is responsible for adapting a resource to a specific property of a particular device. The properties of a device are described in a resource descriptive framework (RDF) for the device. In other words, a handler may take a resource, or content, and adapt it to a particular device, such as a keypad, a color display, and will take into account the specific properties of that device, such as, for example, bandwidth, computational power, memory, image support, sound support and language. For example, in the case of a color display, a handler may adapt the appropriate content such that the content fits within the size of the display screen. A handler may also adapt an image to fit on the screen and convert the image to the appropriate format. Furthermore, a handler may adapt a file in one language to another language, or it may adapt the quality of an audio file based on the bandwidth limitation and memory limitations of the device.

An “engine” is a process and architecture. In the case of embodiments of the present invention, an engine may render a requested object, resource, or document such that it is suitable for display or other use on any device which may receive it, regardless of the type of device or the protocols the device is implementing. An engine may render content based on the capabilities of the device receiving the content as described in the RDF.

There are currently several computer languages on the market for object oriented programming. The most popular of these languages are C++, developed by BELL LABORATORIES in the early 1980's and JAVA, developed by SUN MICROSYSTEMS, INC., in the mid-1990's. JAVA is especially well-suited for development of world wide web and Internet applications. Indeed, it was developed with these environments in mind. However, object oriented programming techniques may be implemented in almost any programming language or system.

The use of object oriented programming techniques may result in faster system development and improved system flexibility. Further, the use of object oriented programming techniques may result in reduced development costs and lower maintenance costs.

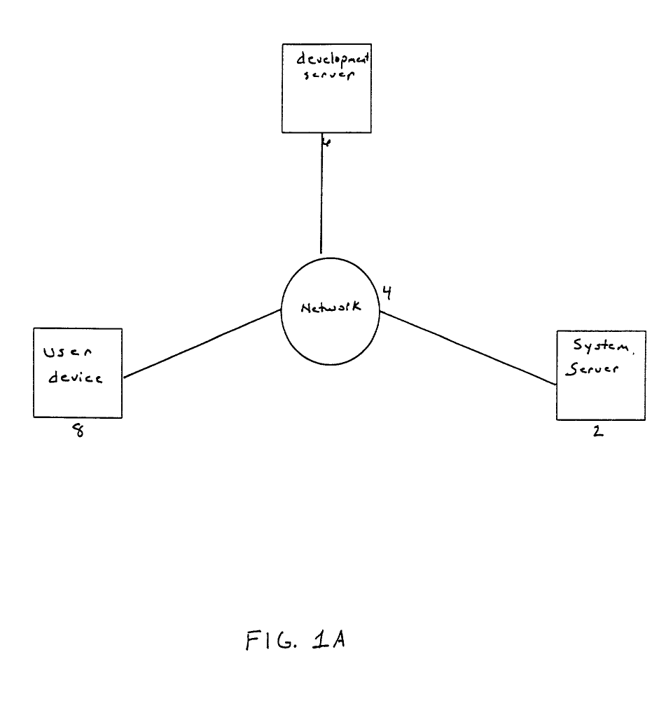

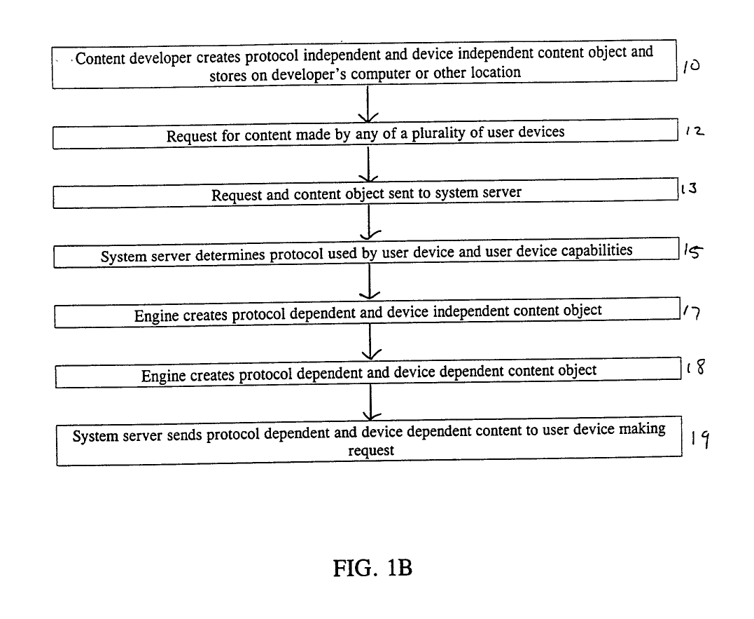

A general environment in which a system according to an embodiment of the present invention may be used is shown in FIG. 1A. A system server 2 on which resides software for rendering content according to an embodiment of the present invention may be connected to a network 4. The system server 2 may be one or more computers or computer systems comprising memory, a processor or processors, input/output devices, networking hardware, and other hardware and software typical for such systems and ubiquitous in the art. One or more terminals, local or remote, may interface with the system server 2.

The network 4 may be a local area network (LAN), a wide area network (WAN), the Internet, or other configuration wherein a plurality of computers are connected with one another and can interface and communicate with one another. For example, the network 4 may be a wireless network wherein some or all devices on the network 4 communicate with each other via a wireless connection.

A development server 6 on which applications to be adapted by the system may be developed may also be connected to the network 4. The development server 6 may also be a computer comprising hardware and software that are typical in the art. Via the network 4, the development server 6 may communicate with the system server 4.

A user device 8 may also connect to the network 4. The user device 8 may be a computer, such as a personal computer or a server, or may be a handheld wireless device, such as a cellular telephone, a personal digital assistant (PDA) or a pager. Alternatively, the user device 8 may be any of a plurality of Internet appliances that currently exist in the marketplace or any other device used for retrieving and utilizing content and information.

General use of the system in the environment described in reference to FIG. 1A may proceed as follows. An application developer may develop content on the application server 6. The application may be, for example, for a website and may include audio, video, text, JPEG images, HTML pages or other information. Alternatively, the content may be for some other type of application, such as, for example, information to be displayed on a cellular telephone display. However, the application developer may develop the application, using API's provided by the system, independent of any particular protocol or device.

Once the application developer has developed the application and it is available for use, it may be loaded and deployed onto the system server 2 and made available so that the user device 8 may make a request. The application may reside on the system server 2, or may reside on another system connected to the network 4. For example, if the application developed by the developer on the development server 6 is for a website, the content may reside on web servers owned and operated by a third party web hosting service with whom the content developer has contracted or otherwise associated.

The request may be sent by the user device 8 to the system server 2. The system server 2 and the software residing thereon may then adapt the application such that it is in a form compatible with the protocol used by and the capabilities of the user device 8 described in the RDF making the request. After rendering, the protocol dependent and device dependent content may then be sent back to the web server or directly to the user device 8 for use by the user device 8.

Embodiments of the invention may be implemented using object oriented programming techniques. For example, FIG. 1B shows a basic flowchart demonstrating how content developed without regard to any particular protocol or device may be adapted to various protocols and devices. Using the API's and processes according to embodiments of the present invention, an application developer may create a content object that is independent of any device or protocol at step 10. The application developer need not be concerned about how the created content may be displayed upon a particular device using a particular protocol. The application developer need only be concerned with the content itself and how the content developer would like the content to be displayed, irrespective of device or protocol. The application may be stored on the application developer's computer or at another location. For example, the application may be stored on a web server operated by a web hosting company or, alternatively, the content may be stored by the system server.

Next, once a content object has been created, at step 12 a request for the content may be made by any of a plurality of user devices. The user devices that may make a request for the content include, but are not limited to, personal computers, personal digital assistants, pagers, cellular telephones, or any other user device capable of making a request for the content.

However, the content, before being rendered or adapted according to an embodiment of the present invention, may be created through the object oriented API's independent of any particular protocol or device, thereby being generally unsuitable for use by the user device making the request for the content. So, the request for content, as well as the content requested, may be sent to the system server at step 13 for rendering.

At step 15, the system server may determine the type of user device making the request and retrieve an RDF for that device that describes the protocol used by the user device and the capabilities of the user device. The protocol and user device may be any protocol or user device desiring to utilize the created content. Protocol and user device information relating to the user device making the request may be included as part of the request. Once the type of user device is determined, the system may select an RDF from a database containing a plurality of protocols and device capabilities maintained by the system and stored by a system storage device.

Once the type of user device making the request, the protocol used by the user device and the capabilities of the user device have been determined, an engine according to an embodiment of the present invention, at step 17, creates an object from the original content object that is independent of any device but dependent upon the protocol of the user device making the request. An engine in this context may mean a process and architecture responsible for rendering or adapting a requested content based on the particular protocol used by the user device making the request.

Following step 17, at step 18 an engine according to an embodiment of the present invention then creates content from the rendered object that is dependent on the protocol of the user device and on the capabilities of the user device. Thus, subsequent to step 18, the content created by the content developer is protocol dependent and device dependent.

At step 19, the created application, which is now protocol dependent and device dependent, may be sent to the user device making the request in a form compatible with the protocol of the user device and the capabilities of the user device. Alternatively, the protocol dependent and device dependent content may be sent to the content developer or a company or service associated with the content developer, such as a web hosting company.

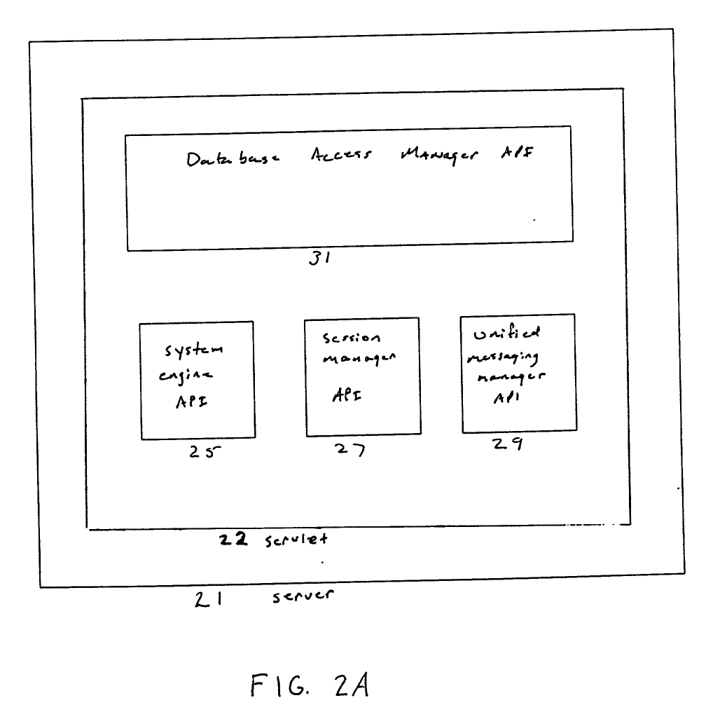

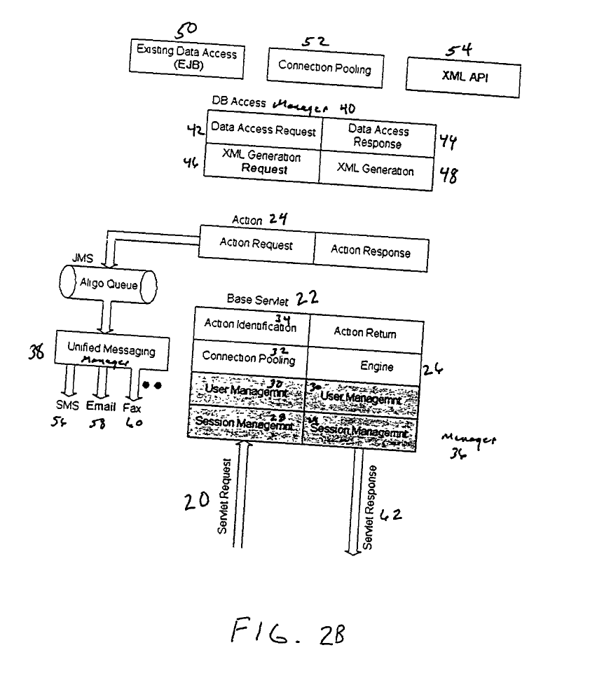

A generalized system according to an embodiment of the present invention on which software for rendering protocol independent and device independent content into protocol dependent and device independent content is shown in FIG. 2A. The system may be implemented in hardware, firmware, software or combinations thereof. A servlet 22 may reside on a system server 21. The servlet 22 is, generally, software that provides system management functions for an entire application. The servlet 22 may use application programming interfaces (API's) to a system engine 25, a session manager 27, a unified messaging manager 29, and a database access manager 31. However, embodiments of the invention need not be dependent on any servlet architecture; any software may use the system engines.

Details of the servlet 22 are shown in FIG. 2B. The servlet may receive a request 20 from a web server or other computer (not shown) or device requesting a session for rendering protocol independent and device independent content into protocol dependent and device dependent content. Upon receiving a servlet request 20, the servlet 22 may set up the session environment, establish proper database connections and unified messaging connections, and perform other system management functions that may be necessary for the session. The servlet 22 may also identify an action 24. An action may be software or code representing content written by an application developer. In some object oriented programming languages, including, but not limited to, JAVA, actions are referred to as abstract classes. In JAVA, an abstract class is a class (i.e., a file, or code) that has methods (i.e., functions that may be used by the servlet 22) and abstract methods (i.e., interfaces that may be used by the servlet 22). Actions may be written by the application developer utilizing API's to a presentation engine 26, session manager 27, unified messaging manager 29 and data access manager 31. The developer may implement an “Execute” method utilizing the API of the system. The Execute method returns a protocol independent and device independent content object to the servlet 22. The servlet 22 passes this object to the presentation engine 26 which returns a protocol dependent device dependent content.

Once the action 24 (or abstract class) has been identified, it is instantiated such that it becomes a protocol independent and device independent object which may be returned to the servlet 22 and then passed to the presentation engine 26. Subsequent to instantiation of the action 24, or abstract class, the content originally created by the developer becomes a device independent, protocol dependent content object through the API's to the presentation engine 26. The servlet may then issue a response 62 back to the web server or the device that originally made the request for content.

According to an embodiment of the present invention, the servlet 22 may be generic to any application. Typically, servlets are dependent on applications; however, embodiments of the present invention, utilizing a generic servlet, are structured such that application developers may develop code without customizing or manipulating a servlet. Embodiments of the present invention allow application developers to focus on building actions, rather than customizing or manipulating a servlet.

As stated above, the servlet 22 may use the API's. An API to a database access manager 40, may include, but is not limited to, interfaces to data access requests 42, data access responses 44, extensible mark-up language (XML) generation requests 46, XML generation 48, access to existing data 50, further connection pooling 52 and XML API's 54 as shown in FIG. 2B.

An API to a unified messaging manager 38 used by the servlet 22 may include, but is not limited to, interfaces to short messages services (SMS) 56, fax 58, email 60, and other modes of communication. An API to a session manager 36 used by the servlet 22 may include, but is not limited to, user management 30 and session management 28. An API to a presentation engine 26 used by the servlet 22 may provide interfaces necessary to instantiate a class created by a content developer into a device independent and protocol independent content object.

The system may also provide a plurality of actions 24. Actions may be classes utilized by the content developer to create the desired content utilizing the API's to the presentation engine 26, session manager 27, unified messaging system manager 29 and data access manager 31. The actions provided by the system may be extended by the content developer such that they may be in a form suitable for processing by the system. Typical actions provided by the system include, but are not limited to, login, page, paragraph, transaction request, form and the like.

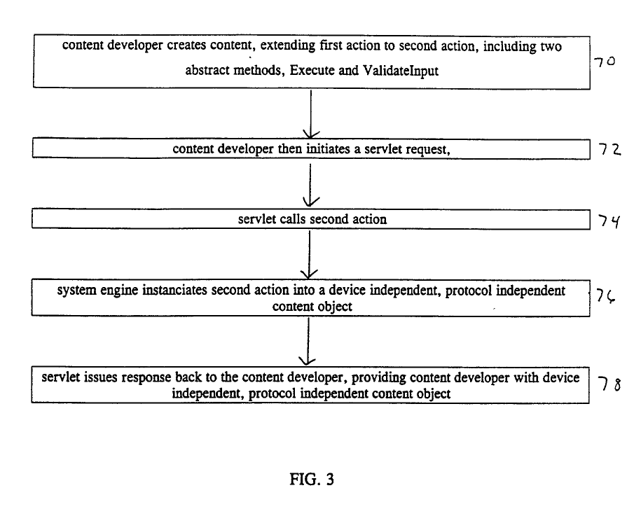

A process demonstrating how an application developer may create a device independent, protocol independent content object according to an embodiment of the present invention is shown in FIG. 3. Using API's according to an embodiment of the present invention, the application developer creates content by writing code representing the desired application at step 70. The API's, as well as class files (i.e., code), and other files comprising an entire platform may be presented to a content developer in a “jar” or, in other words, a zipped up, compressed file system.

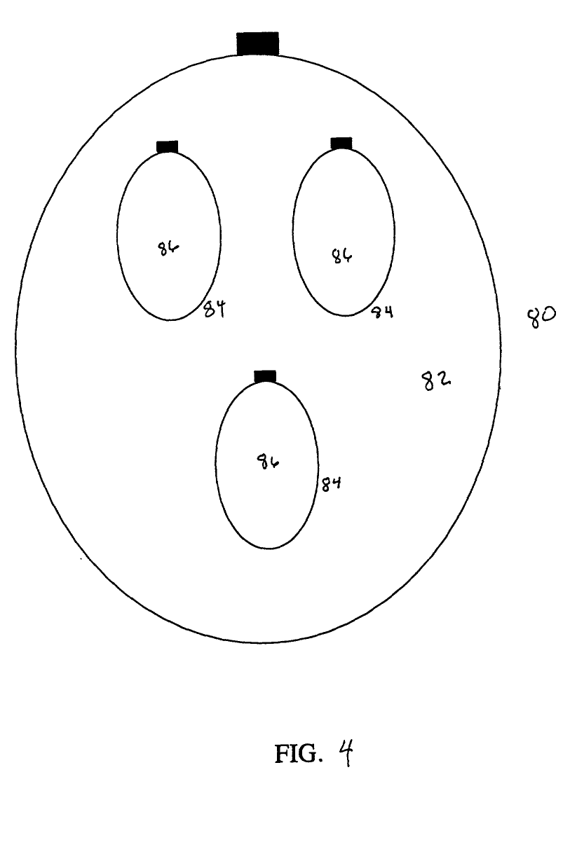

When building an action, a developer may use the API's to the presentation engine 26 to build a device independent, protocol independent content object. The developer may add children, data and attributes to the object as shown in FIG. 4. For example, suppose a content developer desires to create an HTML page for a website on the Internet. Code representing the desired content may then be written in an object oriented fashion using API's provided by the system, which may include, for example, a presentation engine 26, a session manager 27, a unified messaging manager 29 and a data access manager 31, which may be, but need not be, accessed through a servlet 22 by building actions 24, such that when the code is completed it extends a first action provided by the system, thus becoming a second action and considered an abstract class. The first action may include normal methods for which there is actual code, including, but not limited to, the normal methods ExecuteAction and ProcessInvalidate. The second action, or abstract class, which extends the first action, may include two abstract methods, for which code is written by the application developer, including, but not limited to, the abstract methods Execute and ValidateInput, both of which may be written by the content developer using API's provided by the system. Thus, once instantiated, the abstract class, or second action may include two methods: Execute and ValidateInput.

A request from a device may initiate a servlet request at step 72, requesting a session by the servlet so that the content class developed by the application developer may be instantiated to a content object. Upon receiving the servlet request and validating the request, the servlet calls the second action at step 74, subsequent to which a system engine instantiates the second action into a device independent, protocol independent content object at step 76. The servlet then may issue a response back to the device, providing the device with the device independent, protocol independent content object at step 78. The HTML page may be considered to be a document and, as such, the document may need a title. Accordingly, a content developer may instantiate, utilizing classes provided by the system, a document object 80. The content developer may then give the document a name 82. For example, the content developer may call the document “MyDocument.”

The developer may add a title to the document. For example, the content developer may set the title of MyDocument to “Title” using an API provided by an embodiment of the present invention. The title “Title” is now an attribute set for the document. Next, the content developer may give the attribute a value. For example, the content developer may set the title attribute “Title” to “Document X.” Next, the content developer may give the document object a child 84, e.g., a page. Further, the page may be given an attribute 86, such as “page 2.”

Expanding on the example given above, suppose a content developer desires to create a document object. The document object may be given the attribute “title” by the content developer. The document object may also be given children “pages.” The pages, which may be considered objects, may be given attributes, such as “page number” and “paragraph.” The child “paragraph,” which may also be considered an object, may have children “sentences.” The child “sentences,” which may also be considered an object, may have attributes “bold,” “italics,” etc., and children “words.” The children “words,” which may be considered objects, may have attributes “bold,” “italics,” etc. The defining of an object and its attributes and children may continue in this manner at the discretion of the application developer.

As can be seen, an object's data may only be part of a resource. For example, when using a resource such as a video, one object of that resource might have audio as data, another object of that resource might have video without audio as data, or an object of that resource may have both audio and video as data. Thus, a request from a device for a resource might not be just for the data within an object, but for the data contained in multiple objects of an object's children.

If the process according to an embodiment of the present invention were to take place over the Internet, it may proceed as follows. A content developer creates an application by writing code in an object oriented fashion according to a method as described above in reference to FIG. 3. A device may then request a specific action from the servlet residing on the system server by making an HTTP request using a uniform resource locater (URL) identifying the address of the system server. The URL may contain information regarding the specific action requested. For example, if the device requests a login action, the response from the servlet may be “Please enter your username and password.” As another example, if the content developer requests account information the response from the servlet may be “Would you like your account information?”

The servlet may then call a second action, i.e., an abstract class, which may be called ExecuteAction, which, in turn may call methods including, but not limited to, a method called Execute and a method called ValidateInput, if these actions have been implemented by the content developer. The servlet does not know what is inside these methods, these methods having been created by the content developer using API's provided by the system. Indeed, the servlet does not need to know what is inside these methods as long as the methods have been developed using API's provided by the system.

A ValidateInput method may determine whether the session requested by the content developer is valid and may occur by determining whether the content supplied by the content developer is in a form suitable for processing by the system. If a ValidateInput method determines that the content supplied by the end-user is valid, i.e., suitable for processing by the system, an Execute method for that action may be invoked, subsequently creating and passing a content object to a system engine.

If it is determined that the content supplied by the developer is not in a form suitable for processing by the system, the session may be determined to be invalid, and a ProcessInvalidate method may be invoked. The ProcessInvalidate method may generate an exception processing document and pass this document to a system engine.

An example of code written using API's provided by the system to construct a device independent, protocol independent login action may be as follows:

public Class Login extends Action
{
public Am1Document execute (Response response, Request
request)

throws IOException
{
AM1Document document = new Am1Document ( ) ;
//instantiates a new document object
try {
document.setTitle (“WebCo Login”);
Am1Page page = new Am1Page ( ); // instantiates a new
//text object and set attributes
page.setTitle (“”);
page.setId (“WebCO”);
Am1PCData heading = new Am1PCData ( ) ; // instantiates
//a new text object and set attributes
heading.setText (“Welcome to WebCo.com”) ;
page.addAm1PCData (heading); // add text object to page
//object

Am1Form form = new Am1Form ( ); // instantiates a new
//form object and set attributes
form.setURL (URL_MY_WEBCO);
Am1Input input01 = new Am1Input (“text”, “login”); //
instantiates a new //input object and set attributes
input01.setText (“Login: ”);
form.addAm1Input (input01); // add input object to form
//object

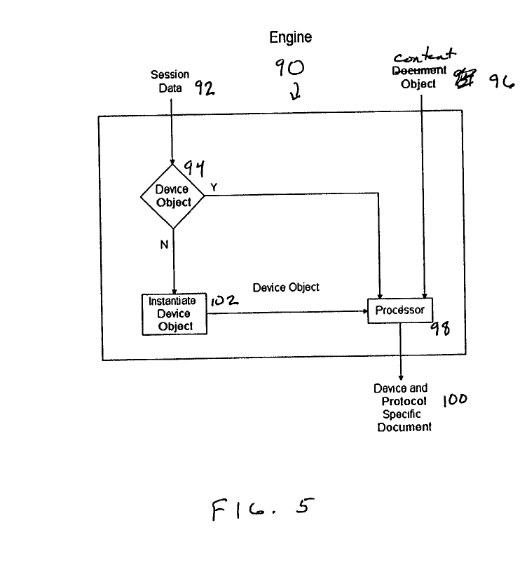

A general process showing how a protocol independent, device independent content object is rendered for a particular device according to an embodiment of the present invention is shown in FIG. 5. As stated previously, a content object may be created after invoking an execute method, which may be entitled Execute, of the system. Once created or otherwise provided, the content object is passed to a system engine 90 (which may be similar to engine 26 in FIG. 2B), as shown in FIG. 5, where it is prepared for a device making the request.

A servlet, such as the servlet 22 as shown in FIGS. 2A and 2B, may identify a particular device making a request and may also identify information particular to that device.

The type of device and its RDF may be stored by the system in the session manager memory or other storage media that may be included with the system. The information relevant to the device RDF may come from an HTTP request or it may be retrieved from a database maintained by the system and stored in system memory or other storage media. If the system cannot ascertain any information about the device making the request, whether from an HTTP request, an internal database, or other source of information, the system may assume a generic device profile (RDF), which may also be stored within the system in system memory or other storage media.

When an engine 90 receives a document object 94 with a request for a session, it may look into session data 92 to determine whether a device object 94 (i.e., a handler representation of the device properties, described below) already exists within the system for the device making the request. If a device object 94 for the device making the request does already exist within the system, the engine 90 passes the device object 94 and the content object 96 to a processor 98. The processor 98 is a mechanism that renders a device independent, protocol independent content object 96 into a device dependent, protocol dependent content object 100. After passing through the processor 98, the content object 96 may be sent to the device making the request in a protocol dependent, device dependent format.

If a device object 94 for the device making the request does not exist within the system, the engine 90 may instantiate an object representation 102 (i.e., a set of handlers for the device, e.g., a handler for display, a handler for memory, a handler for softkeys, etc., described below) for that device. After instantiation of the object representation for the device, the processor 98 may return a protocol dependent, device dependent content object to the device.

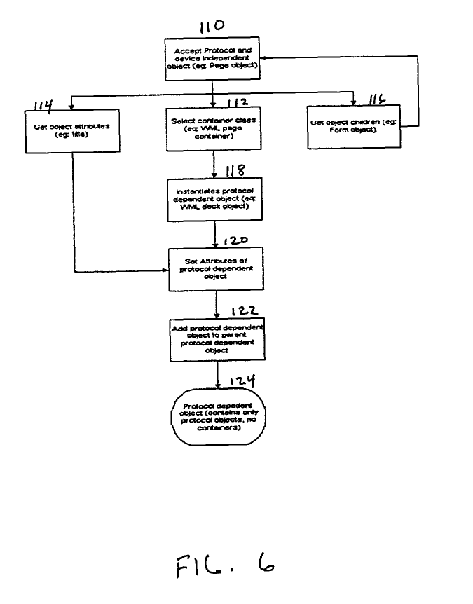

A process showing how a processor according to an embodiment of the present invention, such as a processor 98 shown in FIG. 5, may render a device independent, protocol independent content object into a device independent, protocol dependent content object is shown in FIG. 6. The process shown in FIG. 6 may be referred to as a mapping that is recursively called. A processor receives a protocol independent and device independent object at step 110. The object received may be a large object, such as a document object, or may be children of large objects, such as, in the case of a document object, a page object. For example, a protocol independent and device independent page object may be received at step 110. At step 112, the process may determine which protocol dependent objects the page object may have by ascertaining the protocol used by the device making the request. Explained in another manner, the process at step 112 may determine how a protocol independent object will map to a protocol dependent object.

As another example, assuming a request is for a page object being rendered for a wireless markup language (WML) device, the process at step 112 may determine which protocol dependent objects the page object may have in WML. The rules governing which protocol dependent objects a page object may have may be resident in a WML page container. A container class is a class that may store data and define a particular protocol. In other words, a container may be a mechanism for mapping a protocol independent object to a protocol dependent object. Thus, the process at step 112 will select a protocol dependent container, a WML page container in this example, for the page object, thereby designating which protocol dependent objects the protocol independent page object may have. Once designated, a protocol independent object may be mapped into a protocol dependent container.

At steps 114 and 116, which occur at about the same time as selection of a container class at step 112, the process obtains attributes of an object and children of an object. For example, if a protocol independent and device independent page object is accepted at step 110, the page object may have a “title” attribute. The “title” attribute may then be obtained at step 112. Further, the page object may have object children, such as a “paragraph” object. The “paragraph” object may then be obtained at step 116.

If there are object children at step 116, these children may be mapped into an appropriate container. Thus, as is shown in FIG. 6, the process may recursively call itself from step 116 to step 110. In this manner, all children objects associated with a parent object for which a request has been made may be rendered into an appropriate protocol.

After a container class has been selected and a device independent and protocol independent object has been mapped into it (thereby creating a protocol dependent container for the object), and all attributes and children of the parent object have been obtained, the container class may be instantiated to produce a protocol dependent object at step 118. A container class is instantiated for each parent object and each child object associated with that parent.

At step 120, attributes for each protocol independent and device independent object that were obtained at step 114 are set for the protocol dependent object that was produced at step 118 and, once attributes have been set for all protocol dependent objects, all protocol independent objects associated with the request, including a parent object and all its children objects, may be added together at step 122, resulting in a protocol dependent and device independent object at step 124.

As a representative example of a method for forming a protocol dependent and device independent content object, assume a content developer builds a protocol independent and device independent page object using API's provided by the system as explained above. Referring again to FIG. 6, the protocol and device independent page object may be accepted at step 110.

At step 112, a protocol dependent container class may be selected for the page object (and the page object may be mapped into this container). For example, if the page object is to be displayed on a device using a WML protocol, the protocol dependent container class selected may be a WML page container.

At step 114, attributes of the page object, such as, for example, a title, may be obtained. At step 116, child objects of the page object, such as, for example, a form object, may be obtained and, if so, the process beginning at 110 may be recursively called for such child objects.

At step 118, the protocol dependent container class, into which the protocol independent and device independent page object has been mapped, may be instantiated to produce a protocol dependent and device independent page object. For example, the WML page container class may be instantiated to produce a WML deck object.

At step 120, attributes of the protocol dependent object may be set. At step 122, all protocol dependent object children associated with the parent object that have gone through the process are added to the parent object, resulting in a protocol dependent object at step 124. There are no containers at step 124, only protocol dependent objects.

An example container may be coded as follows:

Wm1Am1Document / / container

Wm1Deck //child object of Wm1Am1Document

Wm1Head //child object of Wm1Deck
Wm1Am1Form //container within Wm1Deck

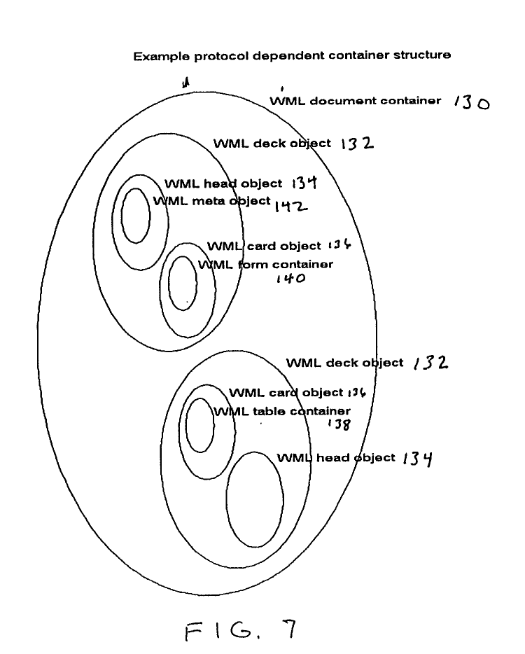

An example of an object representation of a container structure is shown in FIG. 7. In this example, a WML document container 130 comprises WML deck objects 132. In turn, the WML deck objects are further comprised of WML head objects 134 and WML card objects 136. The WML head objects 134 may comprise WML meta objects 142. The WML card objects may comprise WML form container 140 and WML table container 138. In this example, it may be seen how children objects of a parent object may themselves comprise containers by observing that the WML card objects comprise WML form container 140 and WML table container 138.

Once a protocol independent and device independent content object has been rendered into a protocol dependent and device independent content object, a process according to an embodiment of the present invention may render the protocol dependent and device independent content object into a protocol dependent and device dependent content object by registering the protocol dependent and device independent content object with a device handler. A handler may be an object representation of a device and the capabilities of that device. Thus, once a protocol dependent and device independent content object is registered with a handler, the protocol dependent and device independent content object is put into a form that, at least in part, understands the features and limitations of the device. In other words, a handler “handles” the formatting of a content object for use with a particular attribute of the device.

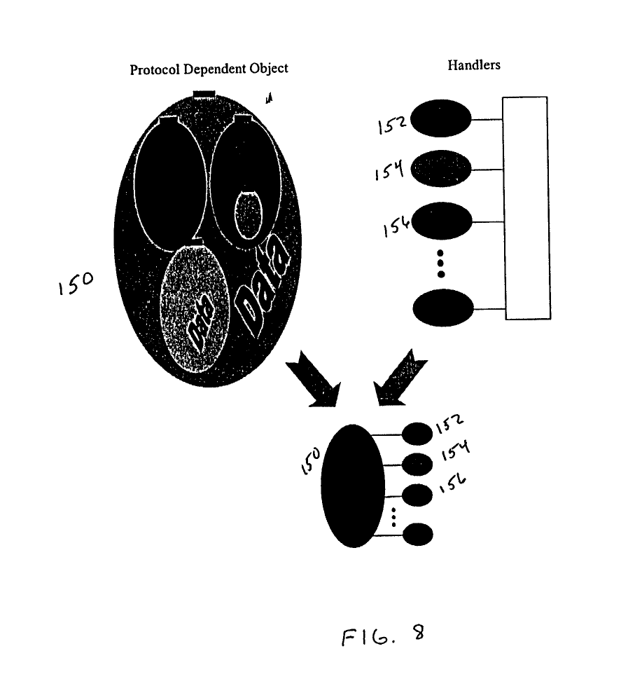

An object representation of how a protocol dependent and device independent content object registers with a handler is shown in FIG. 8. A protocol dependent object 150, which may have data, attributes and children 158, which in turn may have data, attributes and children of its own, may register with handlers 152, 154, 156, each of which may control one property of the device and knows the capabilities of that property as described in the RDF. The object may pass a request for formatting through each handler until a handler responsible for the particular control of that property receives the request.

A device may have a plurality of properties and there may exist a handler for each device property. For example, a device may have properties including, but not limited to, text to speech capability, a display, soft keys, a keyboard, a particular amount of memory, audio and other properties. When a device makes a request, the device may communicate to the handler its capabilities through the RDF. Alternatively, the system according to an embodiment of the present invention may store capabilities (RDF) of a plurality of devices in a database or look-up table. After the capabilities of the device are communicated to the handler, the handler is instantiated with the capabilities for the particular device property for which the handler may be responsible. Thus, each handler may control the rendering of a resource for a certain device property based on the capability of that device.

Further, individual objects may register with the same set of handlers, but each object may instantiate different versions of those handlers. Accordingly, embodiments of the present invention may provide a handler class or classes, but each object may instantiate its own handler. For example, assume an embodiment of the present invention provides as an object a display handler. Every content object that may be processed through a system according to an embodiment of the present invention may register with a copy of the display handler, i.e., a separate instantiation of the display handler.

Alternatively, an object may not register with a handler if a particular device does not have the capability requested. For example, if a content developer creates content that includes audio, and if a request for an audio segment is received by a parent object, if a particular device does not support audio segments, the parent object may not register with a handler that supports audio.

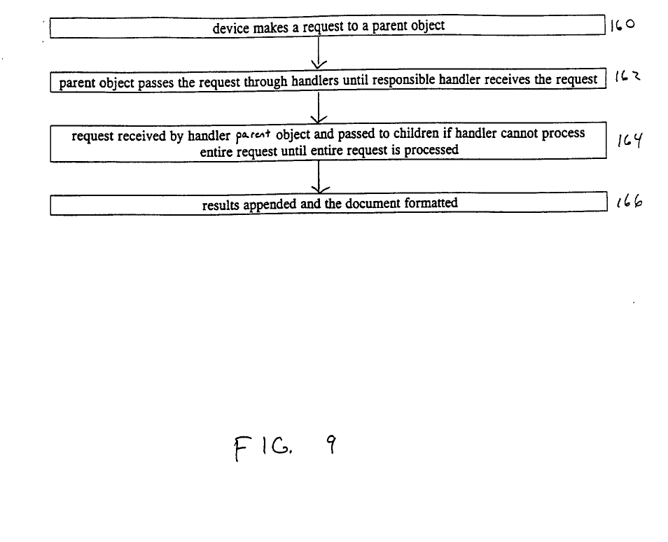

For example, assume a device makes a request to a parent object, for example, a document object, for five lines of display, as shown in FIG. 9. at step 160. At step 162, the parent object passes the request through a set of handlers until a handler responsible for formatting to a display receives the request. The request may first be received by a handler of the parent object at 164, e.g., the document object, a display handler for which may have capability for formatting only one display line. Because this display handler cannot process the entire request, the request is passed to a child of the parent object, a display handler for which may attempt to process the remaining portion of the request. If a display handler for the child object cannot process the remaining portion of the request, the child object may call a next child object, and so on, recursively, until all portions of the request have been processed or, in this example, five lines of display have been formatted. Once all portions of the request have been processed by each display handler, the results may be appended at step 166 and the document formatted for, in this example, five lines.

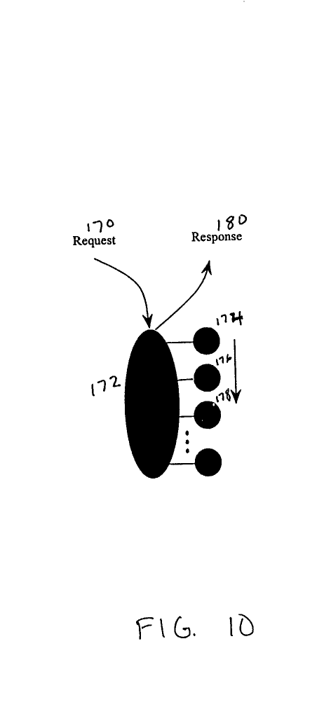

An object representation of a request for rendering content for a particular device is shown in FIG. 10. A request 170 for formatting content is received by a parent object 172. The parent object 172 passes the request through a set of device handlers 174, 176, 178 until a handler responsible for the request receives the request 170. If a relevant handler cannot fulfill the request 170, the request 170 may be passed to a child object and the process may be called recursively and may be repeated until the request 170 is fulfilled. Once the request 170 is fulfilled, the responses may be appended and passed back to the parent object 172, and an aggregate response 180 may be made to the device making the request 170.

Thus, it may be seen that a system and method according to an embodiment of the present invention allows an application developer to create content without regard to a particular protocol or a particular device. The application developer may create a protocol independent and device independent content object through the API's of a presentation engine that may be utilized by any device or any protocol if the content object is created using methods and systems according to embodiments of the present invention. A platform provided by methods and systems according to embodiments of the present invention will automate all steps necessary to render a content object created using methods and systems according to embodiments of the present invention, including but not limited to, session management, connection pooling, access to unified messaging, message queuing, and presentation of dynamic content to multiple devices and protocols.

In the event an application developer desires to create content for a particular device or protocol, methods and systems according to embodiments of the present invention provide a content developer with this capability.

An application developer may utilize secondary APIs provided by the system. Use of a secondary API may consist of a two step process. First, secondary API's may be used to extend a protocol independent object to contain protocol and device specific attributes. The following code provides an example:

Text heading = new Text;
Am1.setText (‘Quantity’);
Am1.setText (‘Wm1’, ‘Qty’);
Am1.addAttribute (‘Soundfile’, ‘quantity.au’);

In the first line above, a text object called heading is created. The second line above sets a text attribute of the protocol and device independent object to “Quantity,” and the third line sets text for a WML specific object to “Qty.” The fourth line adds a sound file to the object that may be used as a voice prompt by a VoiceXML interpreter.

As a second step in using secondary API's according to embodiments of the present invention, the structure of containers that hold protocol specific objects may be developed. The structure may be defined in property file settings or through an XML description that describes a relationship between parent and child objects and attributes. An example of how a content developer may define a container for WML in XML using a secondary API provided by an embodiment of the present invention is as follows:

Wm1Am1Document

Wm1Am1Page // child object of document
Wm1Deck //child object of Wm1Am1Document

Wm1Head //child object of Wm1Deck
Wm1Am1Form //container within Wm1Deck

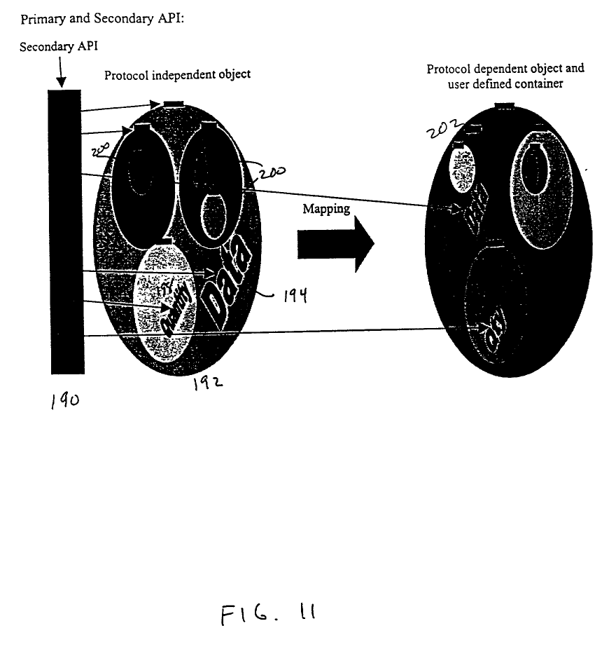

An object representation showing how a protocol independent and device dependent object may be created is shown in FIG. 11. A secondary API 190 may be used to generate a protocol independent object 192, having data 194 and children 196, which in turn may have attributes 198 and children 200. The protocol independent object 192 may be mapped to a protocol dependent and device dependent object 202 using a user defined container rather than a container provided by the system.

While particular embodiments of the present invention have been shown and described, it will be obvious to those skilled in the art that the invention is not limited to the particular embodiments shown and described and that changes and modifications may be made without departing from the spirit and scope of the appended claims.

What is claimed is:

1. A method for creating protocol dependent and device dependent content from protocol independent and device independent content, comprising:
receiving protocol independent and device independent content object;
rendering the protocol independent and device independent content to protocol dependent and device independent content based on a resource descriptive framework (RDF) for a device; and
rendering the protocol dependent and device independent content to protocol dependent and device dependent content based on the RDF for the device.

2. The method of claim 1, wherein the step of rendering the protocol independent and device independent content to protocol dependent and device independent content further comprises mapping the protocol independent and device independent content to a container storing protocol.

3. The method of claim 2, wherein the step of rendering the protocol dependent and device independent content to protocol dependent and device dependent content further comprises registering the protocol dependent and device independent content with a handler storing device capabilities.

4. The method of claim 1, further comprising receiving an extended action from a content developer.

5. The method of claim 1, wherein the step of rendering the protocol independent and device independent content to protocol dependent and device independent content further comprises instantiating a device object based on the RDF for the device.

6. A system for creating protocol dependent and device dependent content from protocol independent and device independent content, comprising:
class files;
application programming interfaces for creating a protocol independent and device independent content object utilizing the class files;
an engine for rendering the protocol independent and device independent content object into protocol dependent and device independent content object; and
an engine for rendering the protocol dependent and device independent content object into protocol dependent and device dependent content object.

7. The system of claim 6, wherein the protocol independent and device independent content object is mapped into a protocol dependent container.

8. The system of claim 6, wherein the protocol dependent and device independent content is registered with a handler.

9. The system of claim 6, wherein the protocol independent and device independent content object is created using object oriented programming.

10. The system of claim 6, wherein the protocol independent and device independent content is created in an execute method that extends a first action.

11. The system of claim 6, wherein the engine instantiates a device object for adapting content for a particular device.

12. The system of claim 6, wherein the protocol dependent and device independent content is registered with a plurality of handlers.

13. A method for creating protocol dependent and device dependent content from protocol independent and device independent content, comprising:
creating protocol independent and device independent content object;
rendering the protocol independent and device independent content to protocol dependent and device independent content; and
rendering the protocol dependent and device independent content to protocol dependent and device dependent content.

14. The method of claim 13, wherein creating protocol independent and device independent content further comprises using object oriented programming.

15. The method of claim 13, wherein the step of creating protocol independent and device independent content further comprises using application programming interfaces.

16. The method of claim 15, wherein the step of using application programming interfaces further comprises implementing an action.

17. A method for building an application once that may be used on multiple devices running multiple protocols, comprising:
creating protocol independent and device independent content;
adapting the content to multiple protocols; and
adapting the application to multiple devices.

18. The method of claim 17, wherein the step of adapting the application to multiple protocols further comprises
selecting one of the multiple protocols; and
adapting the content to the selected protocol.

19. The method of claim 17, wherein the step of adapting the application to multiple devices further comprises
selecting one of the multiple devices; and
adapting the application to the selected device.

20. A method for building an application once that may be used on multiple devices running multiple protocols, comprising:
creating protocol independent and device independent content;
rendering content to multiple devices; and
rendering the content to multiple protocols.

21. A system for creating protocol dependent and device dependent content from protocol independent and device independent content, comprising:
means for creating protocol independent and device independent content object;
means for rendering the protocol independent and device independent content to protocol dependent and device independent content; and
means for rendering the protocol dependent and device independent content to protocol dependent and device dependent content.

22. The system of claim 21, wherein means for creating protocol independent and device independent content comprises means for using object oriented programming.

23. The system of claim 21, wherein the means for creating protocol independent and device independent content further comprises means for using application programming interfaces.

24. The method of claim 23, wherein the means for using application programming interfaces further comprises means for implementing an action.
